(19) United States
(12) Patent Application Publication
(10) Pub. No.: US 2021/0406913 A1
(43) Pub. Date: Dec. 30, 2021

(54) Metric-Driven User Clustering for Online Recommendations

(71) Applicant: Intuit Inc., Mountain View, CA (US)

(72) Inventors: Wen Yao, San Diego, CA (US); Sparsh Gupta, San Diego, CA (US); Zhewen Fan, San Diego, CA (US)

(73) Assignee: Intuit Inc., Mountain View, CA (US)

(21) Appl. No.: 16/916,406

(22) Filed: Jun. 30, 2020

(51) Int. Cl. G06Q 30/00; G06N 5/04; G06N 20/00; G06F 16/35; G06Q 10/06; G06F 40/284

(52) U.S. Cl. CPC G06Q 30/016; G06N 5/04; G06N 20/00; G06Q 40/02; G06Q 10/06315; G06F 40/284; G06F 16/353

(57) ABSTRACT

A method may include receiving an unstructured question from a user having structured contextual features. The unstructured question may include tokens. The method may further include converting, using a sentence embedding model, the tokens to a question vector, assigning the question vector to a question cluster, assigning, by applying a user clustering model to the question cluster and the structured contextual features, the user to a user cluster, and assigning, using a trained machine learning model, a channel to the user cluster. The channel may be used to communicate with a customer service agent for a management application. The trained machine learning model may assign, using metrics, a channel to each user cluster. The method may further include recommending, based on assigning the channel to the user cluster, the channel to the user for the question.

### BACKGROUND

Users of online management applications (MAs) may have difficulty accessing expert assistance to resolve problems with and/or answer questions about the management application. In addition, users typically prefer to decide how they collaborate with agents to obtain assistance. Management applications may provide multiple channels by which users may obtain assistance from agents, such as online chat or requesting a call from an agent, where the user may select a channel based on the user's preferences. However, the selected channel may not be the most effective channel to resolve the problem or answer the question. For example, a user may start on a chat channel and then be escalated to a callback channel if the problem or question is complex. Predicting the most effective channel for an individual user may be challenging due to variations in the circumstances of individual users.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including receiving an unstructured question from a user having structured contextual features. The unstructured question includes tokens. The method further includes converting, using a sentence embedding model, the tokens to a question vector, assigning the question vector to a question cluster, assigning, by applying a user clustering model to the question cluster and the structured contextual features, the user to a user cluster, and assigning, using a trained machine learning model, a channel to the user cluster. The channel is used to communicate with a customer service agent for a management application. The trained machine learning model assigns, using metrics, a channel to each user cluster. The method further includes recommending, based on assigning the channel to the user cluster, the channel to the user for the question.

In general, in one aspect, one or more embodiments relate to a system including a computer processor and a repository configured to store an unstructured question of a user having structured contextual features. The unstructured question includes tokens. The repository is further configured to store a question vector, a user cluster, and a channel used to communicate with a customer service agent for a management application. The system further includes a recommendation engine executing on the computer processor and configured to receive the unstructured question from the user, convert, using a sentence embedding model, the tokens to the question vector, assign the question vector to a question cluster, assign, by applying a user clustering model to the question cluster and the structured contextual features, the user to the user cluster, and assign, using a trained machine learning model, a channel to the user cluster. The trained machine learning model assigns, using metrics, a channel to each user cluster. The recommendation engine is further configured to recommend, based on assigning the channel to the user cluster, the channel to the user for the question.

In general, in one aspect, one or more embodiments relate to a method for training a machine learning model including receiving unstructured questions from users each having structured contextual features. The unstructured questions each include tokens. The method further includes converting, using a sentence embedding model, the tokens of each question to a question vector, assigning each question vector to a question cluster, assigning, by applying a user clustering model to the respective question cluster and the respective structured contextual features, the respective user to a user cluster, and assigning, using metrics, a channel to each user cluster. Each channel is used to communicate with a customer service agent for a management application. Other aspects of the invention will be apparent from the following description and the appended claims.

### BRIEF DESCRIPTION OF DRAWINGS

FIG. 1A and FIG. 1B show a system in accordance with one or more embodiments of the invention.

FIG. 2A and FIG. 2B show flowcharts in accordance with one or more embodiments of the invention.

FIG. 3A, FIG. 3B, FIG. 3C, and FIG. 4 show examples in accordance with one or more embodiments of the invention.

FIG. 5A and FIG. 5B show computing systems in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is often challenging to predict the most effective channel to handle a user's questions about a software application in part due to variations in the circumstances of individual users. Examples of channels may include live chat, requesting a callback from an agent, and scheduling a call with an agent. The effectiveness of a channel may be evaluated relative to various metrics. Examples of metrics may include: net promoter score (tNPS), average handle time (AHT), contact resolution rate, user preference, etc.

The disclosed invention provides a new capability for predicting the most effective channel to handle user questions about a software application. Users are grouped into clusters of users with similar questions and similar contextual features. Examples of contextual features may include categorical features such as aspects of the user's computing environment (e.g., an operating system or hardware platform), a version of the software application, a preferred language of the user, a day of week and/or time of day, etc. Unstructured questions are converted into question vectors which form question clusters. The question clusters may be split into user clusters based on the structured contextual features of the users asking the questions.

A machine learning model is trained using training data that includes user questions, contextual features, the values of various metrics, and the channel selected by the user to handle the question. A sequence of statistical tests is applied to each user cluster until a significant difference among channels is found relative to a metric. When a channel outperforms the other channels relative to a metric, the channel is assigned to the user cluster. If no significant difference is found by applying the statistical tests, then the channel preferred by a majority of the users in the user cluster may be assigned to the user cluster.

When a user submits a question about the software application, the user may be assigned to a user cluster that includes users with similar questions and similar contextual features. The channel assigned to the user cluster may be recommended to the user to handle the user's question. The recommended channel may be more likely to handle the user's question effectively relative to the metrics, thereby improving the efficiency of a call center. In addition, user satisfaction may be improved, resulting in increased product engagement, positive customer ratings, and an increased sales.

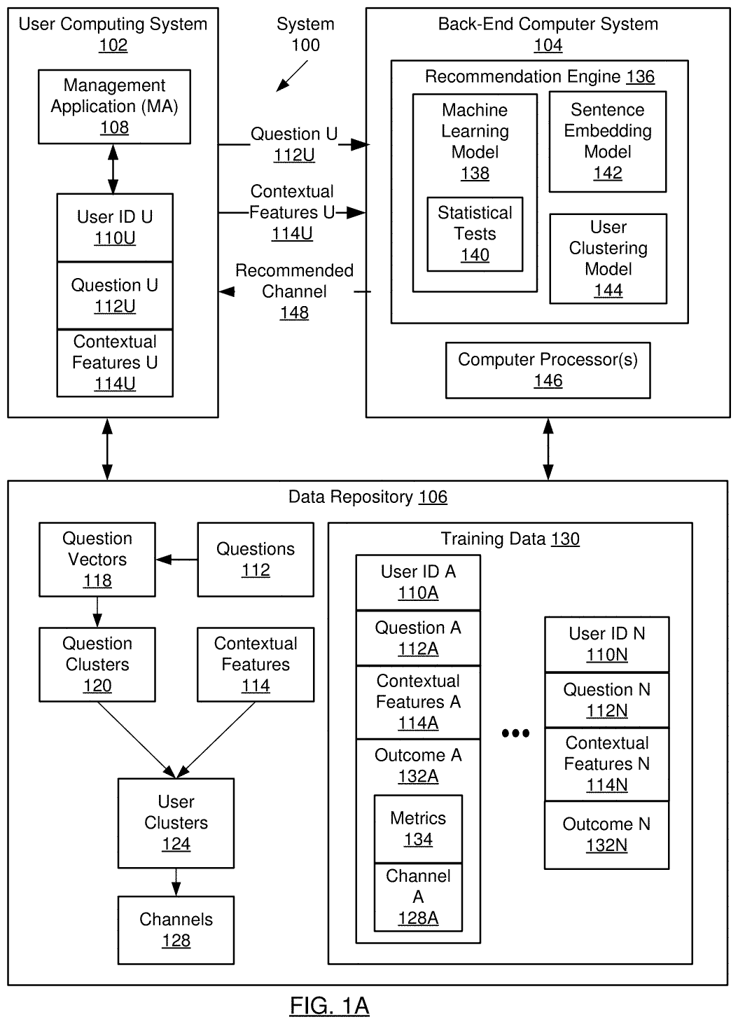

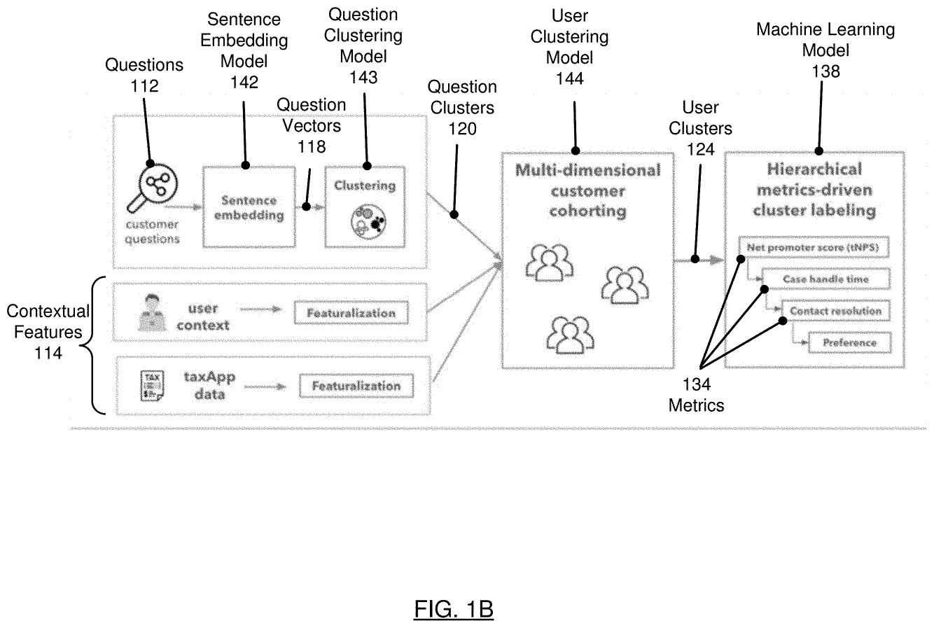

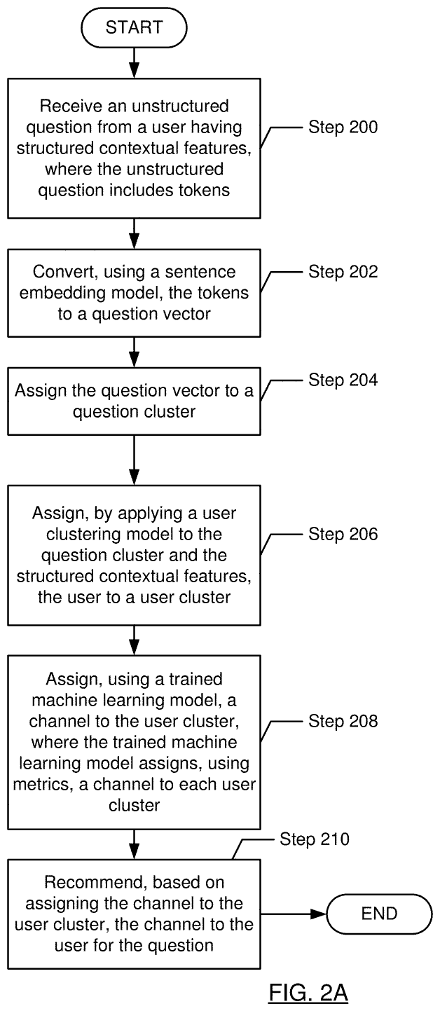

FIG. 1A shows a flow diagram of a system (100) in accordance with one or more embodiments. As shown in FIG. 1A, the system (100) includes multiple components such as the user computing system (102), a back-end computing system (104), and a data repository (106). Each of these components is described below.

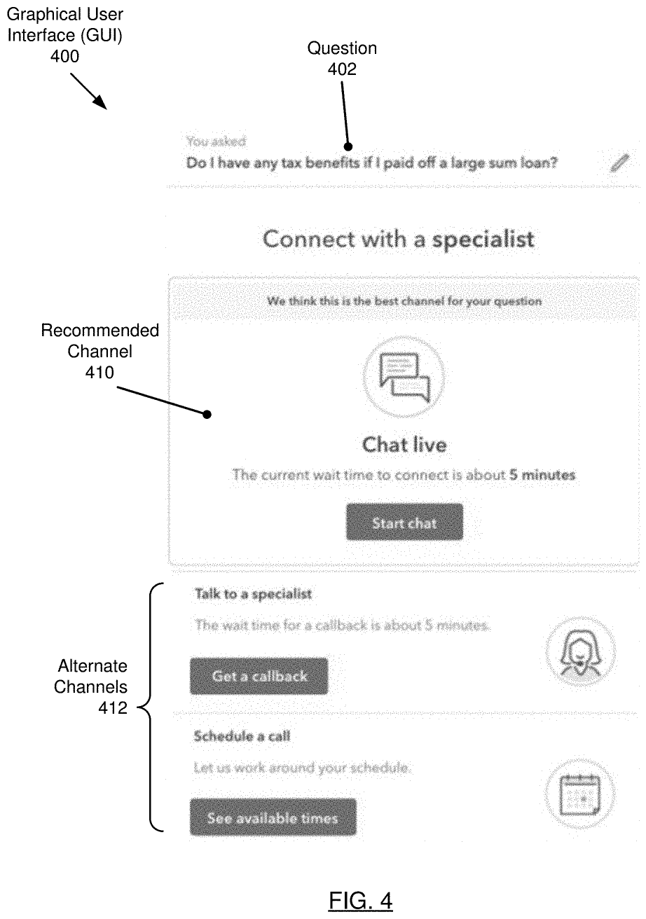

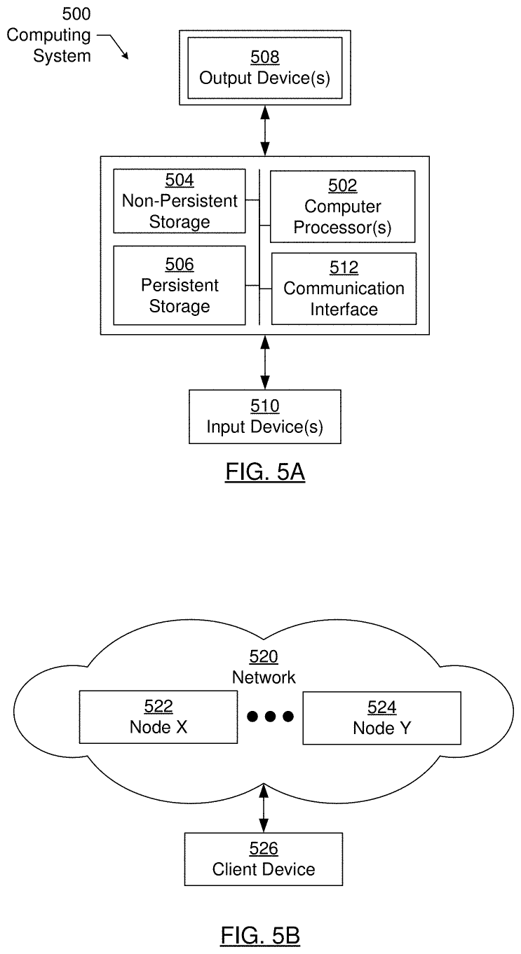

In one or more embodiments, the user computing system (102) provides, to a user, a variety of computing functionality. For example, the computing functionality may include word processing, multimedia processing, financial management, business management, social network connectivity, network management, and/or various other functions that a computing device performs for a user. The user may be a company employee that acts as a sender, a potential sender, or a requestor of services performed by a company (e.g., a client, a customer, etc.) of the user computing system. The user computing system (102) may be a mobile device (e.g., phone, tablet, digital assistant, laptop, etc.) or any other computing device (e.g., desktop, terminal, workstation, etc.) with a computer processor (not shown) and memory (not shown) capable of running computer software. The user computer system (102) may take the form of the computing system (500) shown in FIG. 5A connected to a network (520) as shown in FIG. 5B.

The user computing system (102) includes a management application (MA) (108) in accordance with one or more embodiments. The MA (108), in accordance with one or more embodiments, is a software application written in any programming language that includes executable instructions stored in some sort of memory. The instructions, when executed by one or more processors, enable a device to perform the functions described in accordance with one or more embodiments. In one or more embodiments, the MA (108) is capable of assisting a user with the user's finances or business needs. For example, the MA (108) may be any type of financially-based application such as a tax program, a personal budgeting program, a small business financial program, or any other type of program that assists with finances.

The MA (108) may include a user interface (UI) (not shown) for receiving input from a user and transmitting output to the user. For example, the UI may be a graphical user interface or other user interface. The UI may be rendered and displayed within a local desktop software application or the UI may be generated by a remote web server and transmitted to a user's web browser executing locally on a desktop or mobile device. For example, the UI may be an interface of a software application providing the functionality to the user (e.g., a local gaming application, a word processing application, a financial management application, network management application, business management application etc.). In such a scenario, the help menu, popup window, frame, or other portion of the UI may connect to the MA (108) and present output.

The user computing system (102) further includes, for a user ID (110U), a question (112U) and one or more contextual features (114U) in accordance with one or more embodiments. The user ID (110U), the question (112U), and the contextual features (114U) may be stored in the data repository (106). The user ID (110U) may be an identifier of a user. For example, the user ID (110U) may be an identifying name or alphanumeric string. The question (112U) is unstructured data that includes a sequence of tokens. The tokens may be alphanumeric strings. For example, a token may include a single word, multiple words, a numerical expression, etc. The question (112U) may be a question of the user regarding the use of the MA (108). In one or more embodiments, the question (112U) corresponds to a class (e.g., a category). For example, the class may be a goal of the user asking the question (112U). The question may relate to the use of the MA (108) relative to one or more contextual features (114U) of the user corresponding to a specific user ID (110U).

The contextual features (114U) may be metadata for the question (112U) corresponding to the user ID (110U). The contextual features (114U) are structured data that describe various aspects of the user's interaction with the MA (108). In one or more embodiments, the contextual features (114U) include one or more of the following types of categorical features: an operating system (e.g., an operating system of the user computing system (102)), a hardware platform (e.g., a hardware platform of the user computing system (102)), a version or product stock-keeping unit (SKU) of the MA (108), a preferred language (e.g., a natural language) of the user, a temporal context such as a day of week and/or time of day, a goal (e.g., intent) of the user, etc. A categorical feature is a feature whose corresponding value may be one of a set of discrete values. As an example, a “size” categorical feature may correspond to one of the values “small”, “medium”, or “large.” The temporal context may be relevant to the process of selecting a channel (128) because a given channel may be available on specific days of week and/or times of day.

Additional examples of contextual features (114U) may include status information of the user corresponding to the user ID (110U). The status information may be acquired from the user via the UI of the MA (108) in order for the MA (108) in order to provide a service to the user. For example, if the MA (108) provides a financial service to the user, the status information may include one or more of the following: age, gross income, number of tax forms (e.g., W2 forms, Schedule C forms), capital gains, child credits, etc. The status information may be summarized by a complexity category, such as “simple”, “medium”, and “complex”, depending on the complexity of the status information.

The MA (108) includes functionality to send a question (112U) and contextual features (114U) to the recommendation engine (136) of the back-end computer system (104). Continuing with FIG. 1A, the back-end computer system (104) is communicatively connected to the user computing system (102) such as through one or more networks. The back-end computer system (104) includes the recommendation engine (136) and computer processor(s) (146). The recommendation engine (136) includes a machine learning model (138), a sentence embedding model (142), and a user clustering model (144).

The recommendation engine (136) may include functionality to apply a topic model to the question (112U) to identify the class of the question (112U). For example, the class of the question (112U) may be determined by applying the topic model to the tokens of the question (112U). Examples of classes for a MA (108) that provides tax preparation services may include: expenses, income, loans, etc. The topic model may be based on latent Dirichlet allocation (LDA) or a dynamic topic model (DTM). The topic model may be trained using tokens of a training corpus. For example, the training corpus used to train the topic model may be specific to terminology used in the MA (108).

Continuing with FIG. 1A, the data repository (106) is any type of storage unit and/or device (e.g., a file system, database, collection of tables, or any other storage mechanism) for storing data. Further, the data repository (106) may include multiple different storage units and/or devices. The multiple different storage units and/or devices may or may not be of the same type or located at the same physical site. The data repository (106) may be accessed online via a cloud service (e.g., Amazon Web Services, Egnyte, Azure, etc.).

In one or more embodiments, the data repository (106) includes functionality to store questions (112), question vectors (118), question clusters (120), user clusters (124), contextual features (114), channels (128), and training data (130). Each question vector (118) is an embedding (e.g., a semantic representation) of the tokens of a question (112) corresponding to a specific user. Each question vector (118) may be a vector (e.g., a point) in a multi-dimensional semantic space. The value assigned to a dimension of the question vector (118) may be based on the co-occurrence of a token of the corresponding question (112) with other tokens in a set of training data. The question vectors (118) may be embeddings of the questions (112A, 112N) of the training data (130).

In one or more embodiments, the recommendation engine (136) includes functionality to convert questions (112) into question vectors (118) using the sentence embedding model (142). The sentence embedding model (142) may form the embedding using various cluster analysis techniques (e.g., k-means clustering, centroid-based clustering, hierarchical clustering, distribution-based clustering, density-based clustering, etc.). In one or more embodiments, the embedding is a sent2vec embedding. The sentence embedding model (142) may be trained using a training data corpus that includes questions (112) from users regarding the use of the MA (108).

In one or more embodiments, the recommendation engine (136) includes functionality to group the question vectors (118) into question clusters (120) using a question clustering model. For example, the question clustering model may be based on one of the aforementioned cluster analysis techniques (e.g., k-means clustering). A question cluster may include question vectors (118) that are within a threshold distance of a center of the question cluster. For example, the distance may be based on the cosine similarity among the question vectors (118). Continuing this example, the center of the question cluster may be a point (e.g., a vector) that represents an average of the question vectors (118) in the question cluster.

In one or more embodiments, the recommendation engine (136) includes functionality to adjust one or more hyperparameters of the sentence embedding model (142) to improve the quality of the question clusters (120) formed by the question vectors (118). For example, the hyperparameters may include one or more of the following: the settings of embedding dimensions, the type of n-grams, learning rates, etc. The quality of a question cluster may be measured using the average entropy (e.g., calculated using k-means clustering) of the question cluster relative to the class of the questions (112) from which the question vectors (118) of the question cluster were derived. Alternatively or additionally, the quality of a question cluster may be measured using a loss function applied to an algorithm of the sentence embedding model (142) that generates the question vectors (118).

The recommendation engine (136) includes functionality to form user clusters (124) from question clusters (120) using a user clustering model (144). The user clustering model may be a multi-dimensional model that forms users clusters (124) from question clusters (120) using one or more contextual features (114), as described below in Step 256. Each of the user clusters (124) may correspond to a user cluster identifier.

Channels (128) are communication mechanisms by which users may obtain assistance from agents. For example, the agents may be agents of a call center that provides assistance to users of the MA (108). Continuing this example, an agent may answer a question (112U) of a user corresponding to a user ID (110U) via a channel. Examples of channels (128) may include online chat, a callback from an agent, and a scheduled call with an agent. etc. The recommendation engine (136) may include functionality to send a recommended channel (148) to the MA (108) in response to receiving a question (112U) and contextual features (114U) from the MA (108).

The training data (130) may be used to train the machine learning model (138). In one or more embodiments, the training data (130) includes user IDs (110A, 110N), questions (112A, 112N), and contextual features (114A, 114N), labeled with outcomes (132A, 132N). Each outcome (132A) include the values of one or more metrics (134) and a channel (e.g., channel (128A)) selected by the user corresponding to the user ID (110A)). Thus, feedback regarding channels selected by users may be used to train the machine learning model (138). Examples of metrics (134) may include one or more of the following operational metrics: net promoter score (tNPS), average handle time (AHT), contact resolution rate, etc. The tNPS is a measure of customer loyalty. The AHT is a call center metric that measures the average duration of a call, typically measured from the initiation of the call by the user and including any hold time, talk time, and related tasks that follow the call. The contact resolution rate is the number of calls (e.g., questions) resolved correctly on the first attempt divided by the total number of calls in a given time interval. Another example of a metric is user preference. For example, the user preference metric may indicate, for a given user cluster, the proportions of each channel selected by users in the user cluster.

The machine learning model (138) includes functionality to assign channels (128) to user clusters (124) using one or more statistical tests (140). The machine learning model (138) may apply the statistical tests (140) to the metrics (134) in the outcomes (132A, 132N) of the training data (130) corresponding to each user cluster. Examples of statistical tests (140) may include: t-tests, z-tests, etc. For example, two-sample tests may be used to compare two channels to determine whether there is a significant difference between the two channels relative to a specific metric. In one or more embodiments, the machine learning model (138) applies the statistical tests (140) to the metrics (134) using sequential hypothesis testing, as described below in Step 258. The assignments (e.g., the mappings) of the user clusters (124) to channels (128) may be stored in the data repository (106).

The machine learning model (138) may be implemented as various types of deep learning classifiers such as a neural network classifier (e.g., based on convolutional neural networks (CNNs)), random forest classifier, stochastic gradient descent (SGD) classifier, lasso classifier, gradient boosting classifier such as XGBoost, bagging classifier, adaptive boosting (AdaBoost) classifier, ridge classifier, elastic net classifier, or Nu Support Vector Regression (NuSVR) classifier. Deep learning, also known as deep structured learning or hierarchical learning, is part of a broader family of machine learning methods based on learning data representations, as opposed to task-specific algorithms.

FIG. 1B shows a flow diagram describing how the machine learning model (138) is trained to assign channels (128) to user clusters (124). FIG. 1B shows that questions (112) are converted to question vectors (118) using the sentence embedding model (142). The question clustering model (143) groups question vectors (118) into question clusters (120) (e.g., using k-means clustering). FIG. 1B further shows that question clusters (120) formed by the question vectors (118) are split into user clusters (124) by applying a user clustering model (144) using contextual features (114). The machine learning model (138) is trained to assign channels (128) to user clusters (124) by applying statistical tests (140) to metrics (134) of the user clusters (124).

In one or more embodiments, the computer processor(s) (146) takes the form of the computer processor(s) (502) described with respect to FIG. 5A and the accompanying description below.

While FIG. 1A and FIG. 1B show a configuration of components, other configurations may be used without departing from the scope of the invention. For example, various components may be combined to create a single component. As another example, the functionality performed by a single component may be performed by two or more components.

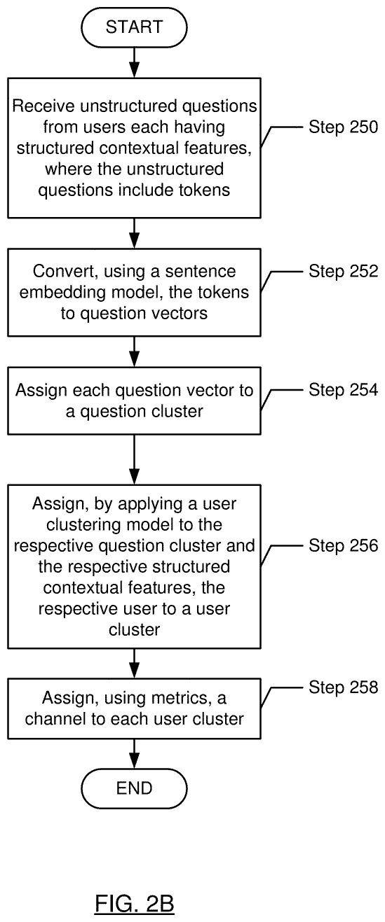

FIG. 2A shows a flowchart in accordance with one or more embodiments of the invention. The flowchart depicts a process for generating a recommendation. One or more of the steps in FIG. 2A may be performed by the components (e.g., the recommendation engine (136) of the back-end computing system (104) and the management application (MA) (108) of the user computing system (102)), discussed above in reference to FIG. 1A. In one or more embodiments of the invention, one or more of the steps shown in FIG. 2A may be omitted, repeated, and/or performed in parallel, or in a different order than the order shown in FIG. 2A. Accordingly, the scope of the invention should not be considered limited to the specific arrangement of steps shown in FIG. 2A.

Initially, in Step 200, an unstructured question is received from a user having structured contextual features. The unstructured question includes tokens. The structured contextual features may include categorical and/or numerical features. The management application may receive the unstructured question and the structured contextual features from the user (e.g., via a graphical user interface (GUI)). The recommendation engine may receive the unstructured question and the structured contextual features from the management application.

In Step 202, the tokens are converted to a question vector using a sentence embedding model. Prior to converting the tokens to the question vector, the recommendation engine may preprocess the unstructured question. For example, the preprocessing may include one or more of the following: extracting HyperText Markup Language (HTML) tags, replacing acronyms with the full form of the acronyms (e.g., replacing “CA” with “California”), converting strings to lowercase, replacing punctuation marks with white space, removing stopwords (e.g., I″, “me”, “and”), etc. The preprocessing may further include performing spell checking using a vocabulary that includes terms specific to the management application. For example, the vocabulary may include tax terms if the management application is a tax preparation application.

In addition, the contextual features may be preprocessed by: 1) removing rows of contextual features that are missing values for one or more of the contextual features; and/or 2) normalizing numeric contextual features (e.g., by converting the numeric contextual features to a common scale).

In Step 204, the question vector is assigned to a question cluster. The recommendation engine may calculate a distance (e.g., based on cosine similarity) between the question vector (generated in Step 202 above using the sentence embedding model) and the question clusters formed by the question clustering model (e.g., the question clusters formed from the training data using k-means clustering). Then, the recommendation engine may assign the question vector to the question cluster with the smallest distance to the question vector.

In Step 206, the user is assigned to a user cluster by applying a user clustering model to the question cluster and the structured contextual features. The recommendation engine may assign the user to the user cluster corresponding to the question cluster assigned in Step 204 above and the structured contextual features of the user. Thus, the user is assigned to a user cluster that includes users having both similar questions and similar contextual features as the user.

In Step 208, a channel is assigned to the user cluster using a trained machine learning model. The trained machine learning model assigns, using metrics, a channel to each of the user clusters, as described in Step 258 below. The recommendation engine may obtain the assignment of the channel to the user cluster from the data repository.

In Step 210, the channel is recommended to the user for the question based on assigning the channel to the user cluster. The assigned channel may represent the most effective channel to handle the question of the user, given the contextual features of the user, as determined by the trained machine learning model using the metrics.

In one or more embodiments, the recommendation engine may receive, in response to recommending the channel, a notification of the outcome of handling of the question. For example, the outcome may include the channel selected by the user (e.g., the user may have selected the recommended channel or the user may have selected a channel that was not recommended), and the values of metrics associated with handling the question via the channel selected by the user. In response to receiving the notification of the outcome, the recommendation engine may update the machine learning model by adding a new record to the training data of the machine learning model that includes the user ID of the user, the question, the contextual features of the user, and the outcome. Thus, the recommendation engine may update the machine learning model as the outcomes of handling questions of users via channels become available.

FIG. 2B shows a flowchart in accordance with one or more embodiments of the invention. The flowchart depicts a process for training a machine learning model. One or more of the steps in FIG. 2B may be performed by the components (e.g., the recommendation engine (136) of the back-end computing system (104) and the management application (MA) (108) of the user computing system (102)), discussed above in reference to FIG. 1A. In one or more embodiments of the invention, one or more of the steps shown in FIG. 2B may be omitted, repeated, and/or performed in parallel, or in a different order than the order shown in FIG. 2B. Accordingly, the scope of the invention should not be considered limited to the specific arrangement of steps shown in FIG. 2B.

Initially, in Step 250, unstructured questions are received from users each having structured contextual features (see description of Step 200 above). Each unstructured question includes tokens. The unstructured questions may be included in training data. Each record in the training data may include a user ID, an unstructured question, contextual features of the user corresponding to the user ID, and an outcome. The outcome includes the values of one or more metrics associated with handling the question via the channel selected by the user.

In Step 252, the tokens are converted to question vectors using a sentence embedding model (see description of Step 202 above).

In Step 254, each question vector is assigned to a question cluster (see description of Step 204 above).

In Step 256, the respective user is assigned to a user cluster by applying a user clustering model to the respective question cluster and the respective structured contextual features (see description of Step 206 above). The user clusters represent different subsets of the training data where each user cluster includes users with similar questions and similar contextual features.

The user clustering model may split a question cluster into two or more user clusters using one or more contextual features of the subset of users corresponding to the questions that were converted to the question vectors of the question cluster. The user clustering model may split a question cluster when the size of the question cluster is above a threshold size. For example, the size of the question cluster may be a count of the question vectors in the question cluster. A contextual feature used to split a question cluster may be any non-homogeneous contextual feature that differentiates the question vectors of the question cluster. Thus, the resulting user clusters may include users that have both similar questions and similar contextual features. The user clustering model may recursively split a user cluster into smaller user clusters using one or more additional contextual features. For example, the user clustering model may recursively split a user cluster when the size of the user cluster is above the threshold size.

In Step 258, a channel is assigned to each user cluster using metrics. The machine learning model may assign a channel to each user cluster by applying one or more statistical tests to the values of the metrics in the outcomes of the subset of the training data corresponding to the user cluster. In one or more embodiments, the machine learning model applies the statistical tests to the values of the metrics using sequential hypothesis testing. That is, the statistical tests may be applied in a sequence until one of the statistical tests shows a significant difference between the values of the metrics for different channels. For example, if the first statistical test in the sequence shows that the callback channel significantly outperforms the other channels relative to a first metric (e.g., the net promoter score (tNPS) metric), then the machine learning model assigns the callback channel to the user cluster. However, if the result of the first statistical test in the sequence is not significant, then the machine learning model applies the second statistical test in the sequence to a second metric (e.g., average handle time (AHT)), and so on, until the result of a statistical test is found to be significant.

If none of the statistical tests produce a significant result, the machine learning model may use the user preference metric to assign a channel to the user cluster. That is, the machine learning model may assign the channel selected by a majority of users in the user cluster. In one or more embodiments, the machine learning model assigns the channel selected by a majority of users in the user cluster when the proportion of users selecting the channel exceeds a threshold proportion. For example, the threshold proportion may be 0.8, indicating that the user preference metric is used to select the channel when the proportion of users selecting the channel exceeds 80%.

Finally, if none of the statistical tests produce a significant result, and the user preference metric is below the threshold proportion, the machine learning model may assign a default channel to the user cluster. For example, the live chat channel may be assigned as a default because it is may be known that users generally prefer live chat over other channels.

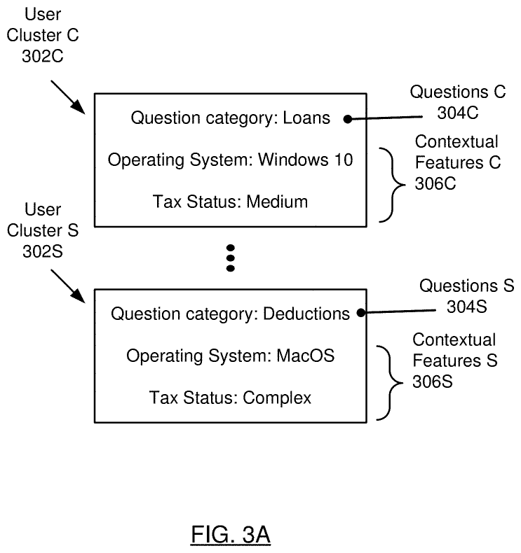

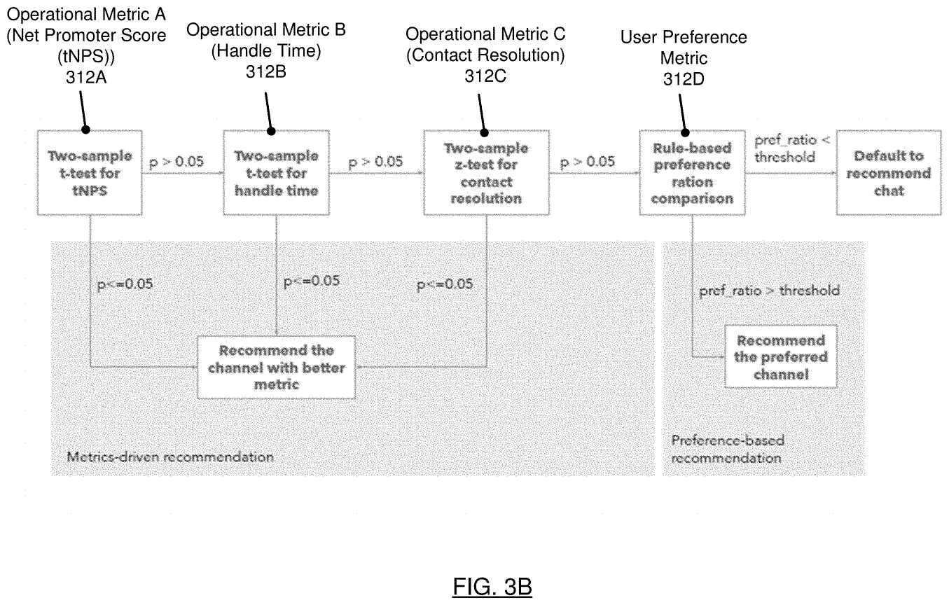

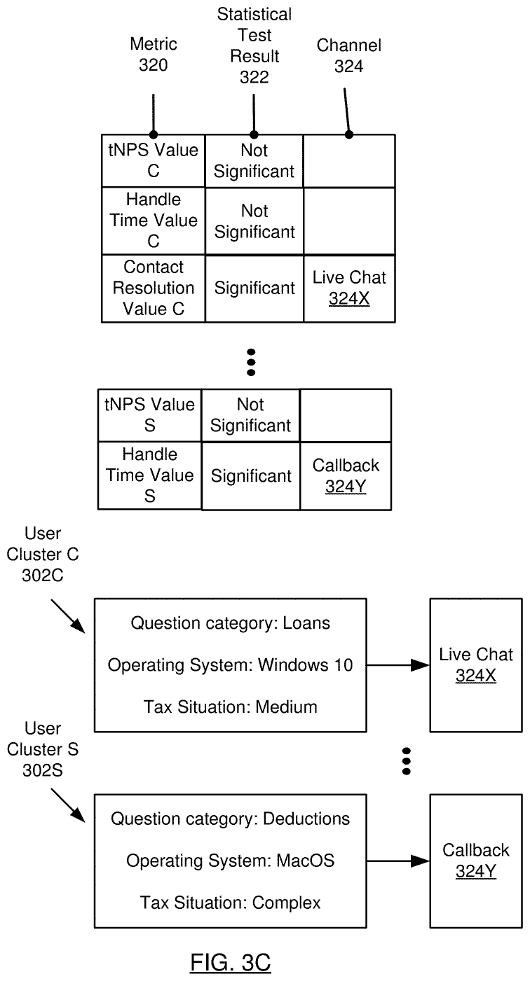

The following example is for explanatory purposes only and not intended to limit the scope of the invention. FIG. 3A shows an implementation example in accordance with one or more embodiments of the invention. FIG. 3A shows user clusters (302C, 302S) ((124) in FIG. 1A and FIG. 1B) each including users with similar questions about the use of a management application (MA), in this case a tax preparation application. The questions (304C) ((112) in FIG. 1A and FIG. 1B) of the users in user cluster C (310C) are about loans. The users in user cluster C (310C) also share common contextual features (306C) ((114) in FIG. 1A and FIG. 1B): a “Windows 10” operating system and a “medium” tax status. The questions (304S) of the users in user cluster S (310S) are about deductions. The users in user cluster S (310S) also share common contextual features (306S): a “MacOS” operating system and a “complex” tax status. The user clusters (302C, 302S) are included in training data for a machine learning model.

FIG. 3B shows a training flow that includes a sequence of statistical tests performed by the machine learning model on operational metrics (312A, 312B, 312C) ((134) in FIG. 1A and FIG. 1B). The training flow of FIG. 3B also includes a comparison of a user preference metric (302D) to a threshold proportion. The machine learning model applies the statistical tests in a sequence until one of the statistical tests shows a significant difference between the values of the metrics (312A, 312B, 312C) for different channels.

FIG. 3C shows statistical test results (322) applied to metrics (320) for the users in each user cluster (302C, 302S). A channel (324) is assigned to a user cluster when the statistical test result is significant, indicating that one channel significantly outperformed the other channels relative to the metric. In the case of user cluster C (302C), the statistical tests were not significant relative to the tNPS metric or the handle time metric. However, the statistical test was significant relative to the contact resolution metric. The machine learning model assigns the live chat channel (324X) to user cluster C (302C) because the live chat channel (324X) outperformed the other channels (e.g., the callback channel and the scheduled call channel) relative to the contact resolution metric. FIG. 3C shows the assignment of the live chat channel (324X) to user cluster C (302C). If none of the statistical tests were significant, then the machine learning model checks whether the proportion of users in user cluster C (302C) preferring any channel exceeded the threshold proportion, in which case the machine learning model would assign the preferred channel to user cluster C (302C).

In the case of user cluster S (302S), the statistical test was not significant relative to the tNPS metric. However, the statistical test was significant relative to the handle time metric. The machine learning model assigns the callback channel (324Y) to user cluster S (302S), because the callback channel (324Y) outperformed the other channels relative to the handle time metric. FIG. 3C shows the assignment of the callback channel (324Y) to user cluster S (302S).

FIG. 4 shows a graphical user interface (GUI) (400) to the management application. The GUI (400) receives a question (402) from a user and sends the question (402) and contextual features of the user to the recommendation engine. The contextual features of the user include a “Windows 10” operating system and a “medium” tax status. The recommendation engine assigns the user to user cluster C (302C) based on the similarity of question (402) to the questions in user cluster C (302C) and the similarity of the contextual features of the user to the contextual features of user cluster C (302C). That is, both the question (402) of the user and the questions of user cluster C (302C) are about “loans”, and both the contextual features of the user and the contextual features of user cluster C (302C) include a “Windows 10” operating system and a “medium” tax status. Because the machine learning model assigned the live chat channel (322X) to user cluster C (302C), the GUI (400) presents the live chat channel (322X) to the user as a recommended channel (410) ((148) in FIG. 1A). The GUI (400) also shows alternate channels (412) in case the user does not wish to use the recommended channel (410).

Embodiments of the invention may be implemented on a computing system. Any combination of mobile, desktop, server, router, switch, embedded device, or other types of hardware may be used. For example, as shown in FIG. 5A, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include and/or perform all or a portion of one or more embodiments of the invention.

The computing system or group of computing systems described in FIGS. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 5A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The computing system in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 5A and the nodes and/or client device in FIG. 5B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
receiving an unstructured question from a user having a first plurality of structured contextual features, wherein the unstructured question comprises a plurality of tokens;
converting, using a sentence embedding model, the plurality of tokens to a question vector;
assigning the question vector to a first question cluster of a plurality of question clusters;
assigning, by applying a user clustering model to the first question cluster and the first plurality of structured contextual features, the user to a user cluster of a plurality of user clusters;
assigning, using a trained machine learning model, a first channel of a plurality of channels to the user cluster,
wherein the plurality of channels are used to communicate with a customer service agent for a management application, and
wherein the trained machine learning model assigns, using a plurality of metrics, one of the plurality of channels to each of the plurality of user clusters; and
recommending, based on assigning the first channel to the user cluster, the first channel to the user for the question.

2. The method of claim 1, further comprising:
adjusting a hyperparameter of the sentence embedding model to reduce an average entropy of the plurality of question clusters.

3. The method of claim 1, further comprising:
training the trained machine learning model using a plurality of training data comprising a plurality of unstructured questions of a plurality of users each labeled with an outcome,
wherein the outcome comprises values of the plurality of metrics and a channel of the plurality of channels selected by the respective user, and
wherein each of the plurality of users has a plurality of structured contextual features.

4. The method of claim 3, further comprising:
converting the plurality of unstructured questions to a plurality of question vectors to obtain a plurality of question clusters; and
splitting a second question cluster of the plurality of question clusters into two or more user clusters using the plurality of structured contextual features of a subset of the plurality of users,
wherein the subset of the plurality of users corresponds to a subset of the plurality of unstructured questions that were converted to a subset of the plurality of question vectors comprised by the second question cluster.

5. The method of claim 4, further comprising:
determining that a size of the second question cluster exceeds a threshold size, wherein the second question cluster is split in response to determining that the size of the second question cluster exceeds the threshold size.

6. The method of claim 3, wherein the trained machine learning model:
for each of the plurality of user clusters, applies one or more statistical tests to the values of the plurality of metrics of the plurality of unstructured questions of the respective user cluster to obtain one or more test results; and
attempts to assign, using the one or more test results, a channel of the plurality of channels to the respective user cluster.

7. The method of claim 6, wherein the trained machine learning model further:
fails to assign, using the one or more test results, a channel to the respective user cluster;
in response to failing to assign a channel to the respective user cluster, determines that a second channel was selected by a proportion of the users of the respective user cluster;
determines that the proportion exceeds a threshold proportion; and
in response to determining that the proportion exceeds the threshold proportion, assigns the second channel to the respective user cluster.

8. The method of claim 1, wherein the first plurality of structured contextual features comprises a feature of a computer system executing the management application.

9. A system, comprising:
a computer processor;
a repository configured to store:
an unstructured question of a user having a first plurality of structured contextual features, wherein the unstructured question comprises a plurality of tokens,
a question vector,
a plurality of user clusters comprising a user cluster, and
a plurality of channels used to communicate with a customer service agent for a management application (MA), wherein the plurality of channels comprises a first channel; and
a recommendation engine, executing on the computer processor and configured to:
receive the unstructured question from the user,
convert, using a sentence embedding model, the plurality of tokens to the question vector,
assign the question vector to a question cluster of a plurality of question clusters,
assign, by applying a user clustering model to the question cluster and the first plurality of structured contextual features, the user to the user cluster,
assign, using a trained machine learning model, the first channel to the first user cluster, wherein the trained machine learning model assigns, using a plurality of metrics, one of the plurality of channels to each of the plurality of user clusters, and
recommend, based on assigning the first channel to the user cluster, the first channel to the user for the question.

10. The system of claim 9, wherein the recommendation engine is further configured to:
adjust a hyperparameter of the sentence embedding model to reduce an average entropy of the plurality of question clusters.

11. The system of claim 9, wherein the recommendation engine is further configured to:
train the trained machine learning model using a plurality of training data comprising a plurality of unstructured questions of a plurality of users each labeled with an outcome,
wherein the outcome comprises values of the plurality of metrics and a channel of the plurality of channels selected by the respective user, and
wherein each of the plurality of users has a plurality of structured contextual features.

12. The system of claim 11, wherein the user clustering model is configured to:
convert the plurality of unstructured questions to a plurality of question vectors to obtain a plurality of question clusters, and
split a second question cluster of the plurality of question clusters into two or more user clusters using the plurality of structured contextual features of a subset of the plurality of users, wherein the subset of the plurality of users corresponds to a subset of the plurality of unstructured questions that were converted to a subset of the plurality of question vectors comprised by the second question cluster.

13. The system of claim 12, wherein the user clustering model is further configured to:
determine that a size of the second question cluster exceeds a threshold size, wherein the second question cluster is split in response to determining that the size of the second question cluster exceeds the threshold size.

14. The system of claim 11, wherein the trained machine learning model is configured to:
for each of the plurality of user clusters, apply one or more statistical tests to the values of the plurality of metrics of the plurality of unstructured questions of the respective user cluster to obtain one or more test results, and
assign, using the one or more test results, a channel of the plurality of channels to the respective user cluster.

15. A method for training a machine learning model comprising:
receiving a plurality of unstructured questions from a plurality of users each having a plurality of structured contextual features, wherein the plurality of unstructured questions each comprise a plurality of tokens;
converting, using a sentence embedding model, each plurality of tokens to a question vector;
assigning each question vector to a question cluster of a plurality of question clusters;
assigning, by applying a user clustering model to the respective question cluster and the respective plurality of structured contextual features, the respective user to a user cluster of a plurality of user clusters; and
assigning, using a plurality of metrics, a channel of the plurality of channels to each of the plurality of user clusters, wherein the plurality of channels are used to communicate with a customer service agent for a management application (MA).

16. The method of claim 15,
wherein each of the plurality of unstructured questions of the plurality of users is labeled with an outcome,
wherein the outcome comprises values of the plurality of metrics and a channel of the plurality of channels selected by the respective user, and
wherein each of the plurality of users has a plurality of structured contextual features.

17. The method of claim 16, further comprising:
converting the plurality of unstructured questions to a plurality of question vectors to obtain a plurality of question clusters; and
splitting a question cluster of the plurality of question clusters into two or more user clusters using the plurality of structured contextual features of a subset of the plurality of users,
wherein the subset of the plurality of users corresponds to a subset of the plurality of unstructured questions that were converted to a subset of the plurality of question vectors comprised by the question cluster.

18. The method of claim 17, further comprising:
determining that a size of the question cluster exceeds a threshold size, wherein the question cluster is split in response to determining that the size of the question cluster exceeds the threshold size.

19. The method of claim 16, further comprising:
for each of the plurality of user clusters, applying one or more statistical tests to the values of the plurality of metrics of the plurality of unstructured questions of the respective user cluster to obtain one or more test results; and
attempting to assign, using the one or more test results, a channel of the plurality of channels to the respective user cluster.

20. The method of claim 19, further comprising:
failing to assign, using the one or more test results, a channel to the respective user cluster;
in response to failing to assign a channel to the respective user cluster, determining that a second channel was selected by a proportion of the users of the respective user cluster;
determining that the proportion exceeds a threshold proportion; and
in response to determining that the proportion exceeds the threshold proportion, assigning the second channel to the respective user cluster.
